(19) United States
(12) Patent Application Publication
(10) Pub. No.: US 2026/0025489 A1
(43) Pub. Date: Jan. 22, 2026

(54) THREE-DIMENSIONAL IMAGING METHOD AND APPARATUS, DEVICE, AND STORAGE MEDIUM

(71) Applicant: JINGDONG TECHNOLOGY HOLDING CO., LTD., Beijing (CN)

(72) Inventors: Yue CHEN, Beijing (CN); Lvsong LI, Beijing (CN); Tao MEI, Beijing (CN)

(73) Assignee: JINGDONG TECHNOLOGY HOLDING CO., LTD., Beijing (CN)

(21) Appl. No.: 18/996,768

(22) PCT Filed: Oct. 11, 2023
(86) PCT No.: PCT/CN2023/123920

§ 371 Date: Jan. 17, 2025

(30) Foreign Application Priority Data
Oct. 19, 2022 (CN) 202211281815.2

(51) Int. Cl. H04N 13/128; H04N 13/15; H04N 13/271

(52) U.S. Cl. CPC H04N 13/128; H04N 13/15; H04N 13/271

(57) ABSTRACT

A three-dimensional imaging method and apparatus includes: acquiring a target color image and original depth map corresponding to a target shooting scene, where the target shooting scene contains at least one transparent object; inputting the target color image into a preset image processing model and, according to an output of the preset image processing model, obtaining a transparent object segmentation result, a boundary prediction result and a normal vector prediction result; based on the transparent object segmentation result, performing cutting processing on the original depth map to obtain a first depth map without transparent object depth information; based on the first depth map, the transparent object segmentation result, the boundary prediction result and the normal vector prediction result, performing depth map global optimization to determine an optimized second depth map; and, based on the second depth map, determining a target three-dimensional image corresponding to the target shooting scene.

This application claims priority to Chinese patent application No. 202211281815.2 filed with the China National Intellectual Property Administration (CNIPA) on Oct. 19, 2022, the disclosure of which is incorporated herein by reference in its entirety.

### TECHNICAL FIELD

Embodiments of the present application relate to computer technology, for example, to a three-dimensional imaging method, a three-dimensional imaging apparatus, a device and a storage medium.

### BACKGROUND

With the rapid development of computer technology, a 3D camera can be used to optically obtain a three-dimensional image of a scene of interest.

At present, three-dimensional imaging methods may include passive binocular three-dimensional imaging, the time-of-flight principle-based three-dimensional imaging and structured light projection three-dimensional imaging. The passive binocular three-dimensional imaging is to indirectly calculate three-dimensional information by triangulation through image feature matching. The time-of-flight principle-based three-dimensional imaging is to directly measure three-dimensional information based on the flight time of light. Structured light projection three-dimensional imaging is to actively project a known coded pattern to improve the feature matching effect.

At least the following problems exist in the related art.

The passive binocular three-dimensional imaging has high requirements for the surface texture features of the object being measured, and cannot measure scenes with unclear textures, so it is not suitable to serve as the imaging method of the eyes of industrial composite robots. The time-of-flight principle-based three-dimensional imaging has a measurement accuracy depending on the accuracy of the light beam detection time, and has poor resolution and accuracy of imaging in close-range scenes, so it is more applied to long-range scenes, such as autonomous driving and long-distance search and detection. In structured light projection three-dimensional imaging, since the projected light is prone to be projected and reflected on transparent objects, it is impossible to effectively perform three-dimensional imaging of transparent objects.

### SUMMARY

A three-dimensional imaging method, a three-dimensional imaging apparatus, a device and a storage medium are provided according to embodiments of the present application to effectively improve the three-dimensional imaging effect of transparent objects in shooting scenes.

In a first aspect, a three-dimensional imaging method is provided according to embodiments of the present application, which includes as follows.

A target color image and an original depth map corresponding to a target shooting scene are acquired, where the target shooting scene contains at least one transparent object.

The target color image is input into a preset image processing model for image processing, and a transparent object segmentation result, a boundary prediction result and a normal vector prediction result in the target shooting scene are obtained according to an output of the preset image processing model.

Based on the transparent object segmentation result, a cutting process is performed on the original depth map to obtain a first depth map without transparent object depth information.

Global optimization of depth information is performed based on the first depth map, the transparent object segmentation result, the boundary prediction result and the normal vector prediction result to determine an optimized second depth map.

A target three-dimensional image corresponding to the target shooting scene is determined based on the second depth map.

In a second aspect, a three-dimensional imaging apparatus is further provided according to embodiments of the present application, which includes: an image acquisition module, a target color image input module, a cutting processing module, a global optimization module and a target three-dimensional image determination module.

The image acquisition module is configured to acquire a target color image and an original depth map corresponding to a target shooting scene, where the target shooting scene contains at least one transparent object.

The target color image input module is configured to input the target color image into a preset image processing model for image processing, and according to an output of the preset image processing model, obtain a transparent object segmentation result, a boundary prediction result and a normal vector prediction result in the target shooting scene.

The cutting processing module is configured to, based on the transparent object segmentation result, perform a cutting process on the original depth map to obtain a first depth map without transparent object depth information.

The global optimization module is configured to perform global optimization of depth information based on the first depth map, the transparent object segmentation result, the boundary prediction result and the normal vector prediction result to determine an optimized second depth map.

The target three-dimensional image determination module is configured to determine a target three-dimensional image corresponding to the target shooting scene based on the second depth map.

In a third aspect, an electronic device is further provided according to embodiments of the present application. The electronic device includes:
at least one processor; and
a memory configured to store at least one program.

The at least one program, when being executed by the at least one processor, causes the at least one processor to implement the three-dimensional imaging method according to any embodiment of the present application.

In a fourth aspect, a computer-readable storage medium is further provided according to embodiments of the present application, in which a computer program is stored. The computer program, when being executed by a processor, implements the three-dimensional imaging method according to any embodiment of the present application.

### BRIEF DESCRIPTION OF DRAWINGS

FIG. 1 is a flow chart of a three-dimensional imaging method according to an embodiment of the present application;

FIG. 2 is an example diagram of a three-dimensional imaging process involved in an embodiment of the present application;

FIG. 3 is a flow chart of another three-dimensional imaging method according to an embodiment of the present application:

FIG. 4 is a schematic structural diagram of a three-dimensional imaging apparatus according to an embodiment of the present application; and

FIG. 5 is a schematic structural diagram of an electronic device according to an embodiment of the present application.

### DETAILED DESCRIPTION

The present application is described in detail below in conjunction with the accompanying drawings and embodiments.

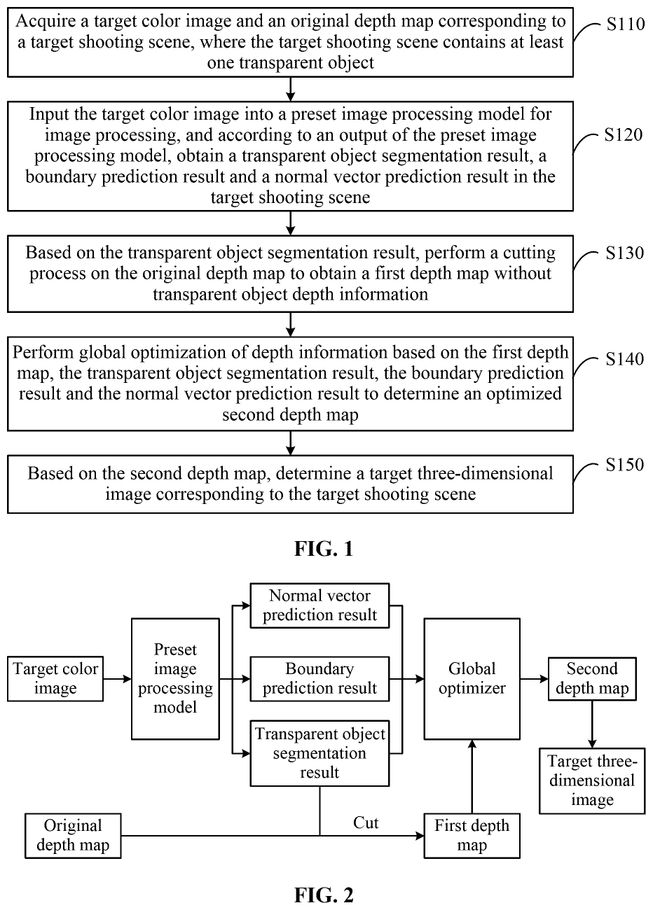

FIG. 1 is a flow chart of a three-dimensional imaging method according to an embodiment of the present application. This embodiment is applicable to the case of performing three-dimensional imaging of a shooting scene containing transparent objects. The method can be performed by a three-dimensional imaging apparatus, and the apparatus can be implemented by software and/or hardware and integrated into an electronic device, such as a 3D camera, or a visual sensor of a composite robot in an industrial scene, so as to assist the robot in completing tasks such as scene recognition and target detection under complex working conditions. As shown in FIG. 1, the method includes the following steps: S110 to S150.

In S110, a target color image and an original depth map corresponding to a target shooting scene are acquired, where the target shooting scene contains at least one transparent object.

The transparent object may include a fully transparent object that allows full transmission of light and a semi-transparent object that allows partial transmission of light, such as a glass cup and a plastic bottle. The target shooting scene may refer to the scene area currently being shot. There may be at least one transparent object in the target shooting scene. There may be only transparent objects in the target shooting scene, or there may be other non-transparent objects in addition to transparent objects. The target color image may be an RGB image synthesized with the three colors of red, blue and green. The original depth map may be a depth map containing transparent object depth information.

For example, a 2D camera may be used to shoot the target shooting scene to obtain a target color image corresponding to the target shooting scene. A 3D camera may be used to shoot the target shooting scene to obtain an original depth map corresponding to the target shooting scene.

In S120, the target color image is input into a preset image processing model for image processing, and a transparent object segmentation result, a boundary prediction result and a normal vector prediction result in the target shooting scene are obtained according to an output of the preset image processing model.

The preset image processing model may be a neural network model for performing transparent object segmentation and extraction on a color image, predicting boundaries between objects in the image, and predicting normal vectors of element positions in the image. A transparent object segmentation result may be represented by a grayscale image, for example, the area where the transparent object is located is a white area with a grayscale value of 255, and the areas other than the area of the transparent object are black areas with a grayscale value of 0. A boundary prediction result may refer to a boundary prediction image whose size is consistent with the size of the input target color image. The boundary between the transparent object and the background and the boundary between the transparent object and the non-transparent object represented by lines are included in the boundary prediction image. A normal vector prediction result may refer to a normal vector prediction image of the same size as the input target color image. In the normal vector prediction image, a different color may be used to represent the normal vector corresponding to each element position in the image. The normal vector corresponding to each element position may refer to the normal vector of the plane formed by the element position and other adjacent element positions. It should be noted that the preset image processing model is obtained by performing model pre-training based on sample data. The sample data includes a sample color image containing at least one transparent object, and a transparent object segmentation label, a boundary label and a normal vector label obtained by calibrating the sample color image.

For example, FIG. 2 shows an example diagram of a three-dimensional imaging process. As shown in FIG. 2, the target color image can be input into a pre-trained preset image processing model, and the preset image processing model can perform image processing on the input target color image, and at the same time determine and output the transparent object segmentation result, boundary prediction result and normal vector prediction result in the target shooting scene, so that the preset image processing model can be used to quickly obtain the transparent object segmentation result, boundary prediction result and normal vector prediction result.

Exemplarily, the preset image processing model may include: an encoding sub-model, a first decoding branch sub-model, a second decoding branch sub-model and a third decoding branch sub-model. Accordingly, S120 may include: inputting the target color image into the encoding sub-model for feature extraction to obtain extracted target image feature information: inputting the target image feature information into the first decoding branch sub-model for transparent object position prediction to determine the transparent object segmentation result; inputting the target image feature information into the second decoding branch sub-model for prediction of the boundary between the transparent object and the non-transparent object to determine the boundary prediction result; and inputting the target image feature information into the third decoding branch sub-model for normal vector prediction corresponding to pixel point positions to determine the normal vector prediction result.

Exemplarily, the encoding sub-model may refer to a network model that performs image encoding on a color image and extracts image features from the color image. For example, it is possible to use only the first two inference stages in the original Swin Transformer network structure as the encoding sub-model, and delete the third and fourth inference stages, thereby reducing the overall time overhead of the model. It is possible to modify the single-branch decoding network in the Swin Transformer network structure into a three-branch decoding network model, namely, the first decoding branch sub-model, the second decoding branch sub-model and the third decoding branch sub-model. The first decoding branch sub-model, the second decoding branch sub-model and the third decoding branch sub-model are three parallel decoding network models for predicting different information, so that the transparent object segmentation result, the boundary prediction result and the normal vector prediction result in the input image can be predicted simultaneously through the first decoding branch sub-model, the second decoding branch sub-model and the third decoding branch sub-model, thereby avoiding repeated reasoning of the encoding network, improving the information prediction efficiency and the three-dimensional imaging efficiency.

In S130, based on the transparent object segmentation result, a cutting process is performed on the original depth map to obtain a first depth map without transparent object depth information.

The first depth map may refer to a depth map that does not contain transparent object depth information. In collecting the original depth map, due to the transmission and reflection of the projected light on the transparent object, the collected transparent object depth information is inaccurate, so it is necessary to cut out the erroneously predicted depth information at the position of the transparent object in the original depth map.

Exemplarily, as shown in FIG. 2, based on the transparent object position information in the transparent object segmentation result, the depth information at the position of the transparent object in the original depth map is determined, and the transparent object depth information in the original depth map is cut and removed, thereby obtaining a first depth map with the erroneously predicted transparent object depth information being removed.

In S140, global optimization of depth information is performed based on the first depth map, the transparent object segmentation result, the boundary prediction result and the normal vector prediction result to determine an optimized second depth map.

The second depth map may be the optimal depth map obtained after the depth information of the first depth map is completed, that is, a depth map containing the most accurate transparent object depth information.

Exemplarily, as shown in FIG. 2, the first depth map, the transparent object segmentation result, the boundary prediction result and the normal vector prediction result may be input into a global optimizer, and the global optimizer solves the optimal solution of the depth information based on the input information, and outputs the obtained optimal depth map, that is, the second depth map, thereby completing the depth information of the depth missing area caused by the object transparency.

Exemplarily, S140 may include: taking a target depth map as an optimization object, and constructing a target optimization function corresponding to the target depth map based on the first depth map, the transparent object segmentation result, the boundary prediction result and the normal vector prediction result; and solving the target optimization function to find a minimum solution, and determining a target depth map corresponding to the minimum solution as the optimized second depth map.

The target depth map may be a depth map obtained by completing the depth information of the first depth map. That is, the target depth map is a complete depth map with the same size as that of the original depth map. The target depth map may refer to the optimization object in the target optimization function. The depth information of each pixel point in the target depth map can be adjusted and optimized so as to determine the optimal depth information corresponding to each pixel point. Exemplarily, during the global optimization of depth information, the position of each pixel point in the target depth map can be modeled based on the first depth map, the transparent object segmentation result, the boundary prediction result and the normal vector prediction result, and a target optimization function is constructed with the target depth map as an optimization object, thereby converting the optimization of the entire depth map into a mathematical process of solving the minimum solution of an n-variable linear polynomial, and the sparse square root Cholesky decomposition method can be used to solve the target optimization function to find the minimum solution. Each solution corresponds to a target depth map containing a specific depth value, and the minimum solution obtained is the optimal solution. The target depth map corresponding to the minimum solution is used as the optimal depth map, that is, the second depth map, thereby achieving depth completion of the depth missing area caused by the transparency of the object.

In S150, a target three-dimensional image corresponding to the target shooting scene is determined based on the second depth map.

For example, as shown in FIG. 2, the complete second depth map after depth completion and optimization can be converted according to pre-calibrated camera parameters to obtain final three-dimensional point cloud data in the target shooting scene, and based on the three-dimensional point cloud data, the target three-dimensional image corresponding to the target shooting scene containing at least one transparent object can be more accurately constructed. By using a preset image processing model and a global optimization method based on the target color image and the original depth map, a set of post-processing optimization processes are implemented, thereby effectively improving the three-dimensional imaging effect of the imaging system for transparent objects under limited computing power overhead.

In the technical solution of this embodiment, the target color image corresponding to the target shooting scene is input into a preset image processing model for image processing, to obtain a transparent object segmentation result, boundary prediction result and normal vector prediction result in the target shooting scene, and based on the transparent object segmentation result, the original depth map corresponding to the target shooting scene is cut to obtain a first depth map with transparent object depth information removed, and global optimization of the depth information is performed based on the first depth map, the transparent object segmentation result, the boundary prediction result and the normal vector prediction result, so as to complete the depth of the depth missing area caused by object transparency, and based on the complete second depth map after completion and optimization, the target three-dimensional image corresponding to the target shooting scene containing at least one transparent object can be more accurately constructed, thereby effectively improving the three-dimensional imaging effect of the transparent object.

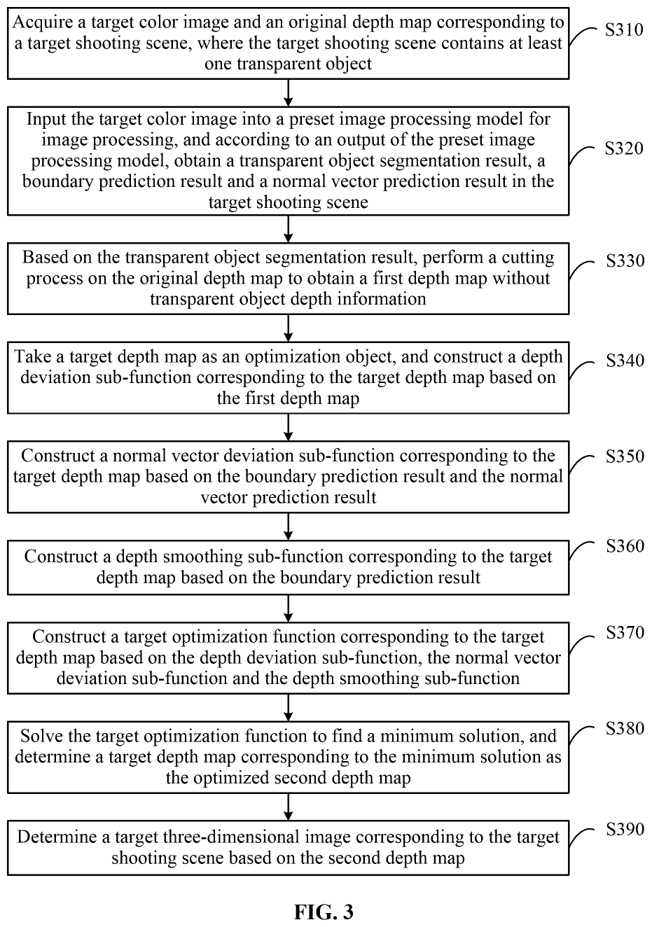

FIG. 3 is a flow chart of another three-dimensional imaging method according to an embodiment of the present application. In this embodiment, the construction process of the target optimization function corresponding to the target depth map is described in detail based on the above embodiment. The explanations of the terms that are the same or corresponding to those in the above embodiment are not repeatedly described here.

Referring to FIG. 3, another three-dimensional imaging method according to this embodiment includes steps S310 to S390 as follows.

In S310, a target color image and an original depth map corresponding to a target shooting scene are acquired, where the target shooting scene contains at least one transparent object.

In S320, the target color image is input into a preset image processing model for image processing, and a transparent object segmentation result, a boundary prediction result and a normal vector prediction result in the target shooting scene are obtained according to an output of the preset image processing model.

In S330, based on the transparent object segmentation result, a cutting process is performed on the original depth map to obtain a first depth map without transparent object depth information.

In S340, a target depth map is taken as an optimization object, a depth deviation sub-function corresponding to the target depth map is constructed based on the first depth map.

Exemplarily, a pixel-level depth deviation loss, i.e., a pixel-level depth deviation sub-function, can be constructed based on depth values of each pixel point in the first depth map and the target depth map, and it can be required that the deviation between the predicted depth value of the current pixel in the target depth map and the original depth value of this pixel in the first depth map is as small as possible.

Exemplarily, S340 may include: obtaining a first depth value corresponding to each first pixel point in the first depth map: determining a depth deviation between the first depth value in the first map and an optimized depth value in the depth map which correspond to the same first pixel point; and constructing a depth deviation sub-function corresponding to the target depth map based on multiple depth deviations.

The first pixel points are pixel points other than transparent object pixel points in the first depth map. The transparent object depth information is cut out from the first depth map, and the transparent object pixel point in the first depth map is an invalid pixel point without a first depth value. In this case, each valid pixel point with a first depth value in the first depth map can be used as the first pixel point, that is, PIE Lobs. The depth value corresponding to each pixel point in the target depth map is referred to as the optimized depth value.

Exemplarily, for each first pixel point, in the first depth map and the target depth map, the depth deviation between a first depth value D₀(p₁) and an optimized depth value D(p₁) corresponding to the same first pixel point p₁ is determined, square values of multiple depth deviations corresponding to multiple first pixel points can be added up, and the obtained addition result is used as a constructed depth deviation sub-function E_{D}. For example, the constructed depth deviation sub-function is:

$${E}_{D} = {\sum }_{{p}_{1} ∈ {T}_{obs}} {‖ D ( {p}_{1} ) - {D}_{0} ( {p}_{1} ) ‖}^{2} .$$

It is to be noted that the depth deviation sub-function does not take invalid pixel points in the first depth map into account, so that for the transparent object area cut out, the deviation of the optimized depth compared with the original depth of each pixel point is not required to be as small as possible, and only the deviation of the optimized depth compared with the original depth of each effective pixel point is required to be as small as possible, so as to ensure the accuracy of the depth optimization of the effective pixel points.

In S350, a normal vector deviation sub-function corresponding to the target depth map is constructed based on the boundary prediction result and the normal vector prediction result.

Exemplarily, it is possible to construct a pixel-level normal vector deviation loss, i.e., a normal vector deviation sub-function based on the normal vector calculated for each pixel point based on the respective pixel point and its adjacent pixel points in the target depth map and the predicted normal vector corresponding to the respective pixel point in the normal vector prediction result, and it can be required that the angle between the normal vector calculated for each pixel point (except the boundary pixel points) based on the respective pixel point and its adjacent pixel points in the target depth map and the predicted normal vector of the respective pixel point in the normal vector prediction result is as small as possible.

Exemplarily, S350 may include: obtaining boundary pixel points in the boundary prediction result: determining a first normal vector corresponding to each second pixel point in the target depth map; obtaining a second normal vector corresponding to each second pixel point in the normal vector prediction result: determining a vector angle corresponding to each second pixel point based on the first normal vector and the second normal vector that correspond to the respective second pixel point; and constructing a normal vector deviation sub-function corresponding to the target depth map according to multiple vector angles.

The second pixel points are pixel points other than the boundary pixel points in the target depth map. Exemplarily, all the pixel points on each boundary in the boundary prediction result may be taken as boundary pixel points, and all the pixel points in the target depth map except all the boundary pixel points may be determined as the second pixel points, that is, p₂∈N. For each second pixel point p₂, a first normal vector v(p₂,q) corresponding to the respective second pixel point may be determined based on a plane defined by the respective second pixel point and its adjacent pixel points q in the four directions of up, down, left, and right in the target depth map, a second normal vector N(p₂) of the respective second pixel point in the normal vector prediction result is obtained, and a vector angle <v(p₂, q), N(p₂)> corresponding to the respective second pixel point is determined based on the first normal vector and the second normal vector which correspond to the respective second pixel point. The square values of the multiple vector angles corresponding to the multiple second pixel points can be added together, and the addition result obtained is used as the constructed normal vector deviation sub-function. For example, the constructed normal vector deviation sub-function is:

$${E}_{N} = {\sum }_{{p}_{2} q ∈ N} {‖ 〈 v ( {p}_{2} , q ) , N ( {p}_{2} ) 〉 ‖}^{2} .$$

It is to be noted that the normal vector deviation sub-function does not take the pixel points predicted as boundary pixel points in the target depth map, so that the normal vectors corresponding to the pixel points at the boundary position in the target shooting scene are allowed to change dramatically, thereby effectively ensuring the accuracy of the depth optimization.

Exemplarily, the determining a first normal vector corresponding to each second pixel point in the target depth map may include: according to the pixel point position of each second pixel point and the two pixel point positions of two adjacent pixel points in each two adjacent directions in the target depth map, determining multiple normal vectors corresponding to each second pixel point, where the adjacent directions include four directions of up, down, left, and right; and averaging the multiple normal vectors corresponding to each second pixel point to determine the first normal vector corresponding to the respective second pixel point.

For example, for each second pixel point, the pixel point position of the respective second pixel point and the two pixel point positions of two adjacent pixel points in its each two adjacent directions can be connected with lines to construct planes corresponding to all the two adjacent directions in the four directions of up, down, left, and right, and the normal vectors of all the planes are determined, the normal vectors corresponding to the respective second pixel point are averaged, and the average normal vector obtained is determined as the first normal vector corresponding to the second pixel point. By averaging the normal vectors corresponding to all the two adjacent directions, the normal vector deviation can be more accurately characterized, thereby improving the global optimization effect of the depth information.

In S360, based on the boundary prediction result, a depth smoothing sub-function corresponding to the target depth map is constructed.

For example, based on the depth values of each pixel point and the adjacent pixel points in the target depth map, a pixel-level depth smoothing loss, i.e., a depth smoothing sub-function, can be constructed, and the depth value changes between each pixel point, except the boundary pixel points, and the adjacent pixel points in the target depth map can be required to be as small as possible.

Exemplarily, S360 may include: obtaining boundary pixel points in the boundary prediction result: determining a change depth between each second pixel point and the adjacent pixel point in each adjacent direction according to the optimized depth value corresponding to the respective second pixel point and the adjacent depth value corresponding to the adjacent pixel point in each adjacent direction in the target depth map; and constructing a depth smoothing sub-function corresponding to the target depth map based on the change depths corresponding to multiple second pixel points in each adjacent direction.

The second pixel points are pixel points other than the boundary pixel points in the target depth map. The adjacent directions include four directions: up, down, left, and right. Exemplarily, all the pixel points on each boundary in the boundary prediction result may be taken as boundary pixel points, and all the pixel points in the target depth map except all the boundary pixel points may be determined as the second pixel points, that is, p₂∈N. For each second pixel point p₂, the optimized depth value D(p₂) corresponding to the respective second pixel point in the target depth map may be subtracted from the adjacent depth value D(q) corresponding to the adjacent pixel point in each adjacent direction to obtain the change depth between the respective second pixel point and the adjacent pixel point in each adjacent direction. For each adjacent direction, the square values of the change depths corresponding to the second pixel points in the respective adjacent direction can be added up, and the obtained addition result is used as the constructed depth smoothing sub-function corresponding to the adjacent direction. For example, the constructed depth smoothing sub-function is:

$${E}_{S} = {\sum }_{{p}_{2} , q ∈ N} {‖ D ( {p}_{2} ) - D ( q ) ‖}^{2} .$$

The multiple depth smoothing sub-functions corresponding to multiple adjacent directions can be solved jointly, or the multiple depth smoothing sub-functions corresponding to multiple adjacent directions can be averaged, and the obtained average function is used as the depth smoothing sub-function.

It is to be noted that the depth smoothing sub-function does not take the consistency of the depth change of the boundary pixel points predicted in the target depth map into consideration, so that the depths of the pixel points at the boundary position in the target shooting scene are allowed to change dramatically, thereby effectively ensuring the accuracy of the depth optimization.

In S370, a target optimization function corresponding to the target depth map is constructed based on the depth deviation sub-function, the normal vector deviation sub-function and the depth smoothing sub-function.

Exemplarily, based on a depth deviation weight λ_{D}, a normal vector deviation weight λ_{N}, and a depth smoothing weight λ_{S}, the depth deviation sub-function, the normal vector deviation sub-function, and the depth smoothing sub-function are weighted and summed, and the summed result is used as the constructed target optimization function E, that is, E=λ_{D}E_{D}+λ_{N}E_{N}+λ_{S}E_{S}, where, the depth deviation weight λ_{D} can be greater than the normal vector deviation weight λ_{N} and the depth smoothing weight λ_{S} to ensure the accuracy of depth optimization. For example, the depth deviation weight λ_{N} can be 1000, and the normal vector deviation weight λ_{N} and the depth smoothing weight λ_{S} can be both 1.

In S380, the target optimization function is solved to find a minimum solution, and a target depth map corresponding to the minimum solution is determined as the optimized second depth map.

Exemplarily, the sparse square root Cholesky decomposition method can be used to solve the target optimization function to find the minimum solution, each solution corresponds to a target depth map, the minimum solution obtained is the optimal solution, and the target depth map corresponding to the minimum solution is used as the optimal depth map, that is, the second depth map, so as to achieve depth completion of the depth missing area caused by the transparency of the object.

In S390, a target three-dimensional image corresponding to the target shooting scene is determined based on the second depth map.

In the technical solution of this embodiment, the depth deviation sub-function, the normal vector deviation sub-function and the depth smoothing sub-function corresponding to the target depth map are respectively constructed, so that global optimization can be performed from aspects of the depth deviation loss, the normal vector deviation loss and the depth smoothing loss, and thereby more accurately performing depth completion, ensuring the global optimization effect of the depth information, and improving the three-dimensional imaging effect of the transparent object.

The following is an embodiment of a three-dimensional imaging apparatus according to an embodiment of the present application. The apparatus and the three-dimensional imaging methods according to the above-described embodiments relate to the same inventive concept. For details not described in detail in the embodiment of the three-dimensional imaging apparatus, reference may be made to the above-described embodiment of the three-dimensional imaging method.

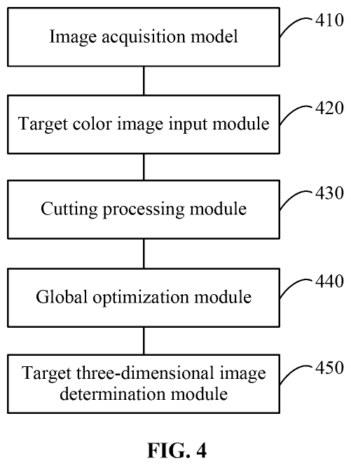

FIG. 4 is a schematic structural diagram of a three-dimensional imaging apparatus according to an embodiment of the present application. This embodiment can be applied to the case of three-dimensional imaging of a shooting scene containing a transparent object. As shown in FIG. 4, the apparatus includes: an image acquisition module 410, a target color image input module 420, a cutting processing module 430, a global optimization module 440 and a target three-dimensional image determination module 450.

Specifically, the image acquisition module 410 is configured to acquire a target color image and an original depth map corresponding to a target shooting scene, where the target shooting scene contains at least one transparent object: the target color image input module 420 is configured to input the target color image into a preset image processing model for image processing, and according to an output of the preset image processing model, obtain a transparent object segmentation result, a boundary prediction result and a normal vector prediction result in the target shooting scene: the cutting processing module 430 is configured to, based on the transparent object segmentation result, perform a cutting process on the original depth map to obtain a first depth map without transparent object depth information: the global optimization module 440 is configured to perform global optimization of depth information based on the first depth map, the transparent object segmentation result, the boundary prediction result and the normal vector prediction result to determine an optimized second depth map; and the target three-dimensional image determination module 450 is configured to determine a target three-dimensional image corresponding to the target shooting scene based on the second depth map.

In the technical solution of this embodiment, the target color image corresponding to the target shooting scene is input into a preset image processing model for image processing, to obtain a transparent object segmentation result, boundary prediction result and normal vector prediction result in the target shooting scene, and based on the transparent object segmentation result, the original depth map corresponding to the target shooting scene is cut to obtain a first depth map with transparent object depth information removed, and global optimization of the depth information is performed based on the first depth map, the transparent object segmentation result, the boundary prediction result and the normal vector prediction result, so as to complete the depth of the depth missing area caused by object transparency, and based on the complete second depth map after completion and optimization, the target three-dimensional image corresponding to the target shooting scene containing at least one transparent object can be more accurately constructed, thereby effectively improving the three-dimensional imaging effect of the transparent object.

Optionally, the global optimization module 440 includes: a target optimization function construction unit and a target optimization function solving unit.

The target optimization function construction unit is configured to take the target depth map as an optimization object, and construct a target optimization function corresponding to the target depth map based on the first depth map, the transparent object segmentation result, the boundary prediction result and the normal vector prediction result, where the target depth map is a depth map obtained after the depth information of the first depth map is completed.

The target optimization function solving unit is configured to solve the target optimization function to find a minimum solution, and determine a target depth map corresponding to the minimum solution as the optimized second depth map.

Optionally, the target optimization function construction unit includes: a depth deviation sub-function construction sub-unit, a normal vector deviation sub-function construction sub-unit, a depth smoothing sub-function construction sub-unit and a target optimization function construction sub-unit.

The depth deviation sub-function construction sub-unit is configured to take the target depth map as an optimization object, and construct a depth deviation sub-function corresponding to the target depth map based on the first depth map.

The normal vector deviation sub-function construction sub-unit is configured to construct a normal vector deviation sub-function corresponding to the target depth map based on the boundary prediction result and the normal vector prediction result.

The depth smoothing sub-function construction sub-unit is configured to construct a depth smoothing sub-function corresponding to the target depth map based on the boundary prediction result.

The target optimization function construction sub-unit is configured to construct a target optimization function corresponding to the target depth map based on the depth deviation sub-function, the normal vector deviation sub-function and the depth smoothing sub-function.

Optionally, the depth deviation sub-function construction sub-unit is configured to:
obtain a first depth value corresponding to each first pixel point in the first depth map, where the first pixel points are pixel points other than transparent object pixel points in the first depth map: determine a depth deviation between the first depth value in the first depth map and an optimized depth value in the target depth map which correspond to the same first pixel point; and construct a depth deviation sub-function corresponding to the target depth map based on multiple depth deviations.

Optionally, the normal vector deviation sub-function construction sub-unit is configured to:
obtain boundary pixel points in the boundary prediction result; determine a first normal vector corresponding to each second pixel point in the target depth map, where the second pixel points are pixel points other than the boundary pixel points in the target depth map: obtain a second normal vector corresponding to each of the second pixel points in the normal vector prediction result: determine a vector angle corresponding to each of the second pixel points based on the first normal vector and the second normal vector which correspond to the respective second pixel point; and construct a normal vector deviation sub-function corresponding to the target depth map according to multiple vector angles.

Optionally, the normal vector deviation sub-function construction sub-unit is further configured to:
determine multiple normal vectors corresponding to each second pixel point according to the pixel point position of the respective second pixel point and the two pixel point positions of two adjacent pixel points in each two adjacent directions in the target depth map, where the adjacent directions include four directions of up, down, left, and right; and average the multiple normal vectors corresponding to each second pixel point to determine the first normal vector corresponding to the respective second pixel point.

Optionally, the depth smoothing sub-function construction sub-unit is configured to:
obtain boundary pixel points in the boundary prediction result: determine a change depth between each second pixel point and the adjacent pixel point in each adjacent direction according to the optimized depth value corresponding to the respective second pixel point and the adjacent depth value corresponding to the adjacent pixel point in each adjacent direction in the target depth map: where the second pixel points are pixel points other than the boundary pixel points in the target depth map; and construct a depth smoothing sub-function corresponding to the target depth map based on the change depths corresponding to multiple second pixel points in each adjacent direction.

Optionally, the preset image processing model includes: an encoding sub-model, a first decoding branch sub-model, a second decoding branch sub-model and a third decoding branch sub-model.

The target color image input module 420 is configured to: input the target color image into the encoding sub-model for feature extraction to obtain extracted target image feature information: input the target image feature information into the first decoding branch sub-model for transparent object position prediction to determine the transparent object segmentation result: input the target image feature information into the second decoding branch sub-model for prediction of the boundary between the transparent object and the non-transparent object to determine the boundary prediction result; and input the target image feature information into the third decoding branch sub-model for normal vector prediction corresponding to pixel point positions to determine the normal vector prediction result.

The three-dimensional imaging apparatus according to the embodiment of the present application can perform the three-dimensional imaging method according to any embodiment of the present application, and has corresponding functional modules for performing the three-dimensional imaging method.

It is worth noting that in the above-described embodiment of the three-dimensional imaging apparatus, the various units and modules included are divided only according to functional logic, are not limited to the above-mentioned division, as long as the corresponding functions can be achieved: in addition, the specific names of the functional units are only for the convenience of distinguishing each other, and are not intended to limit the scope of protection of this application.

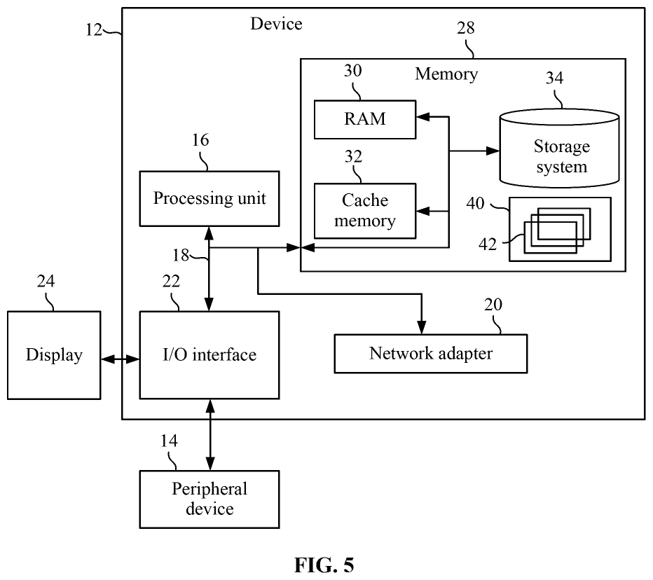

FIG. 5 is a schematic structural diagram of an electronic device according to an embodiment of the present application. FIG. 5 shows a block diagram of an exemplary electronic device 12 suitable for implementing this embodiment of the present application. The electronic device 12 shown in FIG. 4 is merely an example and should not be deemed as imposing any limitations on the functionality and scope of use of the embodiment of the present application.

As shown in FIG. 5, the electronic device 12 is represented in the form of a general purpose computing apparatus. Components of the electronic device 12 may include, but are not limited to, at least one processor or processing unit 16, a system memory 28 and a bus 18 connecting different system components (including the system memory 28 and the processing unit 16).

The bus 18 represents at least one of several types of bus structures, including a memory bus or a memory controller, a peripheral bus, a graphics acceleration port, a processor, or a local bus using any of a variety of bus structures. For example, these architectures include, but are not limited to, an industry standard architecture (ISA) bus, a micro channel architecture (MAC) bus, an enhanced ISA bus, a video electronics standards association (VESA) local bus, and a peripheral component interconnect (PCI) bus.

The electronic device 12 typically includes multiple types of computer system readable medium. These media may be any available medium that can be accessed by the electronic device 12. These media include a volatile medium, a non-volatile medium, a removable medium or a non-removable medium.

The system memory 28 may include a computer system-readable medium in the form of volatile memory, such as a random access memory (RAM) 30 and/or a cache memory 32. The electronic device 12 may further include other removable/non-removable, volatile/non-volatile computer system storage medium. For example only, the storage system 34 may be used to read and write a non-removable medium, or a non-volatile magnetic medium (not shown in FIG. 5, commonly referred to as a “hard drive”). Although not shown in FIG. 5, a magnetic disk drive used to read and write a removable non-volatile magnetic disk (e.g., floppy disk) and an optical disk drive configured to read and write a removable non-volatile optical disk (e.g., a compact disc-read only memory, (CD-ROM), a digital video disk read-only memory (DVD-ROM), or other optical media) may be provided. In these cases, each drive may be connected to the bus 18 via at least one data media interface. The system memory 28 may include at least one program product having a set of (e.g., at least one) program modules configured to perform the functions of the embodiments of the present application.

A program/utility 40, having a set of (at least one) program modules 42, may be stored, for example, in the system memory 28. Such program modules 42 include, but are not limited to, an operating system, at least one application program, other program modules, or program data, any one or a certain combination of which may include an implementation of a network environment. The program modules 42 generally perform the described functions and/or methods in the embodiments of the present application.

The electronic device 12 may communicate with at least one peripheral device 14 (for example, a keyboard, a pointing terminal, or a display 24), may communicate with at least one terminal that enable a user to interact with the electronic device 12, and/or may communicate with any device (for example, a network interface controller or a modem) that enables the electronic device 12 to communicate with at least one other computing device. Such communication may be performed through an input/output (I/O) interface 22. Further, the electronic device 12 may also communicate with at least one network, such as a local area network (LAN), a wide area network (WAN), and/or a public network, such as the Internet, through a network adapter 20. As shown, the network adapter 20 communicates with other modules of the electronic device 12 via the bus 18. It is to be understood that although not shown in the figures, other hardware and/or software modules may be used in conjunction with the electronic device 12. The other hardware and/or software modules include, but are not limited to, microcodes, a terminal driver, a redundant processing unit, an external disk drive array, a redundant arrays of independent disks (RAID) system, a tape driver, a data backup storage system and the like.

The processing unit 16 runs a program stored in the system memory 28, to execute multiple functional applications and perform data processing, for example, implementing the steps of a three-dimensional imaging method according to any embodiment of the present application, which includes:
acquiring a target color image and an original depth map corresponding to a target shooting scene, where the target shooting scene contains at least one transparent object;
inputting the target color image into a preset image processing model for image processing, and according to an output of the preset image processing model, obtaining a transparent object segmentation result, a boundary prediction result and a normal vector prediction result in the target shooting scene;
based on the transparent object segmentation result, performing a cutting process on the original depth map to obtain a first depth map without transparent object depth information;
performing global optimization of depth information based on the first depth map, the transparent object segmentation result, the boundary prediction result and the normal vector prediction result to determine an optimized second depth map; and
based on the second depth map, determining a target three-dimensional image corresponding to the target shooting scene.

Of course, the person skilled in the art can understand that the processor can also implement the technical solution of the three-dimensional imaging method according to any embodiment of the present application.

It is provided according to the embodiment a computer-readable storage medium storing a computer program. When the computer program is executed by a processor, steps of a three-dimensional imaging method according to any embodiment of the present application are implemented, the method includes:
acquiring a target color image and an original depth map corresponding to a target shooting scene, where the target shooting scene contains at least one transparent object;
inputting the target color image into a preset image processing model for image processing, and according to an output of the preset image processing model, obtaining a transparent object segmentation result, a boundary prediction result and a normal vector prediction result in the target shooting scene;
based on the transparent object segmentation result, performing a cutting process on the original depth map to obtain a first depth map without transparent object depth information;
performing global optimization of depth information based on the first depth map, the transparent object segmentation result, the boundary prediction result and the normal vector prediction result to determine an optimized second depth map; and
based on the second depth map, determining a target three-dimensional image corresponding to the target shooting scene.

The computer storage medium in embodiments of the present application may be embodied as any combination of at least one computer-readable medium. The computer-readable medium may be a computer-readable signal medium or a computer-readable storage medium. The computer-readable storage medium may be, but is not limited to, an electrical, magnetic, optical, electromagnetic, infrared or semiconductor system, apparatus or component, or any combination thereof. More specific examples of computer-readable storage medium (a non-exhaustive list) include: electrical connection having at least one wire, portable computer disks, hard disks, random access memories (RAMs), read-only memories (ROMs), erasable programmable read-only memories (EPROMs, or flash memories), optical fibers, portable compact disk read-only memories (CD-ROM), optical storage component, magnetic storage component, or any suitable combination thereof. Herein, the computer-readable storage medium may be any tangible medium including or storing a program. The program may be used by or used in conjunction with an instruction execution system, apparatus or component.

The computer-readable signal medium may include a data signal propagated in a baseband or a data signal propagated as part of a carrier. The data signal carries computer-readable program codes. The data signal may be propagated in multiple forms, which include but are not limited to, an electromagnetic signal, an optical signal, or any suitable combination thereof. The computer-readable signal medium may further be any computer-readable medium besides the computer-readable storage medium. The computer-readable medium can send, propagate, or transmit the program used by or used in conjunction with the instruction execution system, device, or component.

The program codes included in the computer-readable medium may be transmitted in any suitable medium, including, but not limited to, a wireless medium, a wired medium, an optical cable, radio frequency (RF), and the like, or any suitable combination thereof.

Computer program codes for performing the operations of the present application may be written in at least one programming languages or a combination thereof, and the programming languages include object-oriented programming languages such as Java, Smalltalk, C++, and further include conventional procedural programming languages such as “C” programming language or similar programming languages. The program codes may be executed entirely on a user computer, may be executed partly on the user computer, may be executed as a stand-alone software package, may be executed partly on the user computer and partly on a remote computer, or may be executed entirely on the remote computer or a server. In a case involving a remote computer, the remote computer may be connected to the user's computer through any kinds of network, including a local area network (LAN) or a wide area network (WAN), or may be connected to an external computer (e.g., connected through Internet by using an Internet service provider).

A person skilled in the art should understand that the above-described modules or steps of the present application may be implemented by a general-purpose computing apparatus, they may be centralized on a single computing apparatus or distributed over a network composed of multiple computing apparatuses, optionally they may be implemented by program codes executable by the computer apparatus, so that they may be stored in a memory and executed by the computing apparatus, or they may be separately fabricated into multiple integrated circuit modules, or multiple modules or steps thereof may be fabricated into a single integrated circuit module. In this way, the present application is not limited to any specific combination of hardware and software.

Note that the above are only optional embodiments of the present application and the technical principles used. A person skilled in the art will understand that the present application is not limited to the specific embodiments described herein, and that various obvious changes, readjustments and substitutions may be made by a person skilled in the art without departing from the scope of protection of the present application. Therefore, although the present application has been described in detail through the above embodiments, the present application is not limited to the above embodiments, and may include more other equivalent embodiments without departing from the concept of the present application. The scope of the present application is determined by the scope of the attached claims.

1. A three-dimensional imaging method, comprising:
acquiring a target color image and an original depth map corresponding to a target shooting scene, wherein the target shooting scene contains at least one transparent object;
inputting the target color image into a preset image processing model for image processing, and according to an output of the preset image processing model, obtaining a transparent object segmentation result, a boundary prediction result and a normal vector prediction result in the target shooting scene;
based on the transparent object segmentation result, performing a cutting process on the original depth map to obtain a first depth map without transparent object depth information;
performing global optimization of depth information based on the first depth map, the transparent object segmentation result, the boundary prediction result and the normal vector prediction result to determine an optimized second depth map; and
based on the second depth map, determining a target three-dimensional image corresponding to the target shooting scene.

2. The method according to claim 1, wherein performing global optimization of the depth information based on the first depth map, the transparent object segmentation result, the boundary prediction result and the normal vector prediction result to determine the optimized second depth map comprises:
taking a target depth map as an optimization object, and constructing a target optimization function corresponding to the target depth map based on the first depth map, the transparent object segmentation result, the boundary prediction result and the normal vector prediction result, wherein the target depth map is a depth map obtained after depth information of the first depth map is completed; and
solving the target optimization function to find a minimum solution, and determine a target depth map corresponding to the minimum solution as the optimized second depth map.

3. The method according to claim 2, wherein taking the target depth map as the optimization object, and constructing the target optimization function corresponding to the target depth map based on the first depth map, the transparent object segmentation result, the boundary prediction result and the normal vector prediction result comprises:
taking the target depth map as an optimization object, and constructing a depth deviation sub-function corresponding to the target depth map based on the first depth map;
constructing a normal vector deviation sub-function corresponding to the target depth map based on the boundary prediction result and the normal vector prediction result;
constructing a depth smoothing sub-function corresponding to the target depth map based on the boundary prediction result; and
constructing a target optimization function corresponding to the target depth map based on the depth deviation sub-function, the normal vector deviation sub-function and the depth smoothing sub-function.

4. The method according to claim 3, wherein constructing the depth deviation sub-function corresponding to the target depth map based on the first depth map comprises:
obtaining a first depth value corresponding to each first pixel point in the first depth map, wherein the first pixel points are pixel points other than transparent object pixel points in the first depth map;
determining a depth deviation between the first depth value in the first depth map and an optimized depth value in the target depth map which correspond to a same first pixel point; and
constructing a depth deviation sub-function corresponding to the target depth map based on a plurality of depth deviations.

5. The method according to claim 3, wherein the constructing the normal vector deviation sub-function corresponding to the target depth map based on the boundary prediction result and the normal vector prediction result comprises:
obtaining boundary pixel points in the boundary prediction result;
determining a first normal vector corresponding to each second pixel point in the target depth map, wherein second pixel points are pixel points other than boundary pixel points in the target depth map;
obtaining a second normal vector corresponding to each of the second pixel points in the normal vector prediction result;
determining a vector angle corresponding to each of the second pixel points based on the first normal vector and the second normal vector that correspond to a respective second pixel point; and
constructing a normal vector deviation sub-function corresponding to the target depth map according to a plurality of vector angles.

6. The method according to claim 5, wherein determining the first normal vector corresponding to each second pixel point in the target depth map comprises:
according to a pixel point position of each second pixel point and two pixel point positions of two adjacent pixel points in each two adjacent directions in the target depth map, determining a plurality of normal vectors corresponding to each second pixel point, wherein the adjacent directions comprise four directions of up, down, left, and right; and
averaging the plurality of normal vectors corresponding to each second pixel point to determine the first normal vector corresponding to each second pixel point.

7. The method according to claim 3, wherein constructing the depth smoothing sub-function corresponding to the target depth map based on the boundary prediction result comprises:
obtaining boundary pixel points in the boundary prediction result;
determining a change depth between each second pixel point and an adjacent pixel point in each adjacent direction according to an optimized depth value corresponding to each second pixel point and an adjacent depth value corresponding to the adjacent pixel point in each adjacent direction in the target depth map; wherein the second pixel points are pixel points other than the boundary pixel points in the target depth map; and
constructing a depth smoothing sub-function corresponding to the target depth map based on change depths corresponding to a plurality of second pixel points in each adjacent direction.

8. The method according to claim 1, wherein the preset image processing model comprises: a coding sub-model, a first decoding branch sub-model, a second decoding branch sub-model and a third decoding branch sub-model; and
inputting the target color image into the preset image processing model for image processing comprises:
inputting the target color image into the coding sub-model for feature extraction to obtain extracted target image feature information;
inputting the target image feature information into the first decoding branch sub-model for position prediction of a transparent object to determine the transparent object segmentation result;
inputting the target image feature information into the second decoding branch sub-model for prediction of a boundary between a transparent object and a non-transparent object to determine the boundary prediction result; and
inputting the target image feature information into the third decoding branch sub-model for normal vector prediction corresponding to pixel point positions to determine the normal vector prediction result.

9. (canceled)

10. An electronic device, comprising:
at least one processor; and
a memory configured to store at least one program;
wherein the at least one program, when being executed by the at least one processor, causes the at least one processor to implement a three-dimensional imaging method;
wherein the three-dimensional imaging method comprises:
acquiring a target color image and an original depth map corresponding to target shooting scene, wherein the target shooting scene contains at least one transparent object;
inputting the target color image into preset image processing model for image processing, and according to an output of the preset image processing model, obtaining a transparent object segmentation result, a boundary prediction result and a normal vector prediction result in the target shotting scene;
based on the transparent object segmentation result, performing a cutting process on the original depth map to obtain a first depth map without transparent object depth information;
performing global optimization of depth information based on the first depth map, the transparent object segmentation result, the boundary prediction result and the normal vector prediction result to determine an optimized second depth map; and
based on the second depth map, determining a target three-dimensional image corresponding to the target shooting scene.

11. A non-transitory computer-readable storage medium, storing a computer program, wherein the computer program, when being executed by a processor, implements a three-dimensional imaging method;
wherein the three-dimensional imaging method comprises:
acquiring a target color image and an original depth map corresponding to target shooting scene, wherein the target shooting scene contains at least one transparent object;
inputting the target color image into preset image processing model for image processing, and according to an output of the preset image processing model, obtaining a transparent object segmentation result, a boundary prediction result and a normal vector prediction result in the target shotting scene;
based on the transparent object segmentation result, performing a cutting process on the original depth map to obtain a first depth map without transparent object depth information;
performing global optimization of depth information based on the first depth map, the transparent object segmentation result, the boundary prediction result and the normal vector prediction result to determine an optimized second depth map; and
based on the second depth map, determining a target three-dimensional image corresponding to the target shooting scene.

12. The method according to claim 2, wherein the preset image processing model comprises: a coding sub-model, a first decoding branch sub-model, a second decoding branch sub-model and a third decoding branch sub-model; and
inputting the target color image into the preset image processing model for image processing comprises:
inputting the target color image into the coding sub-model for feature extraction to obtain extracted target image feature information;
inputting the target image feature information into the first decoding branch sub-model for position prediction of a transparent object to determine the transparent object segmentation result;
inputting the target image feature information into the second decoding branch sub-model for prediction of a boundary between a transparent object and a non-transparent object to determine the boundary prediction result; and
inputting the target image feature information into the third decoding branch sub-model for normal vector prediction corresponding to pixel point positions to determine the normal vector prediction result.

13. The method according to claim 3, wherein the preset image processing model comprises: a coding sub-model, a first decoding branch sub-model, a second decoding branch sub-model and a third decoding branch sub-model; and
inputting the target color image into the preset image processing model for image processing comprises:
inputting the target color image into the coding sub-model for feature extraction to obtain extracted target image feature information;
inputting the target image feature information into the first decoding branch sub-model for position prediction of a transparent object to determine the transparent object segmentation result;
inputting the target image feature information into the second decoding branch sub-model for prediction of a boundary between a transparent object and a non-transparent object to determine the boundary prediction result; and
inputting the target image feature information into the third decoding branch sub-model for normal vector prediction corresponding to pixel point positions to determine the normal vector prediction result.

14. The method according to claim 4, wherein the preset image processing model comprises: a coding sub-model, a first decoding branch sub-model, a second decoding branch sub-model and a third decoding branch sub-model; and
inputting the target color image into the preset image processing model for image processing comprises:
inputting the target color image into the coding sub-model for feature extraction to obtain extracted target image feature information;
inputting the target image feature information into the first decoding branch sub-model for position prediction of a transparent object to determine the transparent object segmentation result;
inputting the target image feature information into the second decoding branch sub-model for prediction of a boundary between a transparent object and a non-transparent object to determine the boundary prediction result; and
inputting the target image feature information into the third decoding branch sub-model for normal vector prediction corresponding to pixel point positions to determine the normal vector prediction result.

15. The method according to claim 5, wherein the preset image processing model comprises: a coding sub-model, a first decoding branch sub-model, a second decoding branch sub-model and a third decoding branch sub-model; and
inputting the target color image into the preset image processing model for image processing comprises:
inputting the target color image into the coding sub-model for feature extraction to obtain extracted target image feature information;
inputting the target image feature information into the first decoding branch sub-model for position prediction of a transparent object to determine the transparent object segmentation result;
inputting the target image feature information into the second decoding branch sub-model for prediction of a boundary between a transparent object and a non-transparent object to determine the boundary prediction result; and
inputting the target image feature information into the third decoding branch sub-model for normal vector prediction corresponding to pixel point positions to determine the normal vector prediction result.

16. The method according to claim 6, wherein the preset image processing model comprises: a coding sub-model, a first decoding branch sub-model, a second decoding branch sub-model and a third decoding branch sub-model; and
inputting the target color image into the preset image processing model for image processing comprises:
inputting the target color image into the coding sub-model for feature extraction to obtain extracted target image feature information;
inputting the target image feature information into the first decoding branch sub-model for position prediction of a transparent object to determine the transparent object segmentation result;
inputting the target image feature information into the second decoding branch sub-model for prediction of a boundary between a transparent object and a non-transparent object to determine the boundary prediction result; and
inputting the target image feature information into the third decoding branch sub-model for normal vector prediction corresponding to pixel point positions to determine the normal vector prediction result.

17. The method according to claim 7, wherein the preset image processing model comprises: a coding sub-model, a first decoding branch sub-model, a second decoding branch sub-model and a third decoding branch sub-model; and
inputting the target color image into the preset image processing model for image processing comprises:
inputting the target color image into the coding sub-model for feature extraction to obtain extracted target image feature information;
inputting the target image feature information into the first decoding branch sub-model for position prediction of a transparent object to determine the transparent object segmentation result;
inputting the target image feature information into the second decoding branch sub-model for prediction of a boundary between a transparent object and a non-transparent object to determine the boundary prediction result; and
inputting the target image feature information into the third decoding branch sub-model for normal vector prediction corresponding to pixel point positions to determine the normal vector prediction result.

18. The electronic device according to claim 10, wherein performing global optimization of the depth information based on the first depth map, the transparent object segmentation result, the boundary prediction result and the normal vector prediction result to determine the optimized second depth map comprises:
taking a target depth map as an optimization object, and constructing a target optimization function corresponding to the target depth map based on the first depth map, the transparent object segmentation result, the boundary prediction result and the normal vector prediction result, wherein the target depth map is a depth map obtained after depth information of the first depth map is completed; and
solving the target optimization function to find a minimum solution, and determine a target depth map corresponding to the minimum solution as the optimized second depth map.

19. The electronic device according to claim 18, wherein taking the target depth map as the optimization object, and constructing the target optimization function corresponding to the target depth map based on the first depth map, the transparent object segmentation result, the boundary prediction result and the normal vector prediction result comprises:
taking the target depth map as an optimization object, and constructing a depth deviation sub-function corresponding to the target depth map based on the first depth map;
constructing a normal vector deviation sub-function corresponding to the target depth map based on the boundary prediction result and the normal vector prediction result;
constructing a depth smoothing sub-function corresponding to the target depth map based on the boundary prediction result; and
constructing a target optimization function corresponding to the target depth map based on the depth deviation sub-function, the normal vector deviation sub-function and the depth smoothing sub-function.

20. The electronic device according to claim 19, wherein constructing the depth deviation sub-function corresponding to the target depth map based on the first depth map comprises:
obtaining a first depth value corresponding to each first pixel point in the first depth map, wherein the first pixel points are pixel points other than transparent object pixel points in the first depth map;
determining a depth deviation between the first depth value in the first depth map and an optimized depth value in the target depth map which correspond to a same first pixel point; and
constructing a depth deviation sub-function corresponding to the target depth map based on a plurality of depth deviations.

21. The electronic device according to claim 19, wherein the constructing the normal vector deviation sub-function corresponding to the target depth map based on the boundary prediction result and the normal vector prediction result comprises:
obtaining boundary pixel points in the boundary prediction result;
determining a first normal vector corresponding to each second pixel point in the target depth map, wherein second pixel points are pixel points other than boundary pixel points in the target depth map;
obtaining a second normal vector corresponding to each of the second pixel points in the normal vector prediction result;
determining a vector angle corresponding to each of the second pixel points based on the first normal vector and the second normal vector that correspond to a respective second pixel point; and
constructing a normal vector deviation sub-function corresponding to the target depth map according to a plurality of vector angles.
